(19) United States
(12) Patent Application Publication
(10) Pub. No.: US 2020/0139588 A1
(43) Pub. Date: May 7, 2020

(54) Device for recycling and recycling waste tires

(71) Applicant: Huimiao Wang, Jinhua City (CN)

(72) Inventor: Huimiao Wang, Jinhua City (CN)

(21) Appl. No.: 16/734,408

(22) Filed: Jan. 6, 2020

(30) Foreign Application Priority Data
Sep. 19, 2019 (CN) 2019108855547

(51) Int. Cl. B29B 17/02; B29B 17/00

(52) U.S. Cl. CPC B29B 17/02; B29L 2030/00; B29B 17/0047

(57) ABSTRACT

The invention discloses a device for recycling waste tires, which includes a machine body. The upper end of the machine body is provided with an inlet with an upward opening on the right side of the body. The left wall of the inlet is connected with a chute. The chute is provided with A steel wire removal device, a crushing cavity is connected to the lower wall of the inlet, and a crushing device is fixed in the crushing cavity. A twisting cavity is provided in the left wall of the crushing cavity and below the chute. A fourth motor is fixed in the wall, and an eccentric wheel is dynamically connected to the lower end of the fourth motor. The invention can quickly and accurately pull out the steel wire layer in the tire and twist the broken rubber stuck on the steel wire, so that the steel wire and the tire are cleaned. Recyclable materials such as rubber are separated. At the same time, the tires that have been torn out of the steel wire are broken into small pieces of rubber, which is convenient for the next processing, which not only saves the company a lot of material costs, but also saves a lot of time costs and labor.

### CROSS-REFERENCES TO RELATED APPLICATIONS

The present application claims priority from Chinese application No. 2019108869126 filed on Sep. 19, 2019 which is hereby incorporated by reference in its entirety.

### TECHNICAL FIELD

The invention relates to the technical field of tire recycling equipment, and in particular to a device for recycling and recycling waste tires.

### BACKGROUND OF THE INVENTION

With the booming development of the automobile industry, people's lives are inseparable from cars. The use of cars is accompanied by the constant replacement of tires. There are still a large number of recyclable materials in discarded tires, which can save businesses A large amount of raw material costs, and thus the expansion of economic benefits, most of the current tire recycling equipment can only remove the steel wire in the tire, and the steel wire is still stuck with a lot of broken rubber, making it impossible to directly process the steel wire and Waste some rubber material. The present invention illustrates a device capable of solving the above problems.

### BRIEF SUMMARY OF THE INVENTION

### Technical Problem

Most of the current tire recycling equipment can only remove the steel wire in the tire, and the steel wire still has a lot of broken rubber stuck on it, making it impossible to directly process the wire and waste some rubber material.

In order to solve the above problems, this example designs a device for recycling and recycling waste tires. The device for recycling and recycling waste tires in this example includes a machine body. A sliding groove is connected to the left wall of the entrance, and a steel wire removing device is provided in the sliding groove. The steel wire removing device includes a slider provided in the sliding groove which can slide left and right. A first spring is fixedly connected between the chute, a first hydraulic arm is fixed on the upper end surface of the slider, a hook is fixed on the right end of the first hydraulic arm, and a crushing cavity is connected to the lower wall of the inlet. A crushing device is fixed in the crushing cavity, and the crushing device includes left and right symmetrical and rotatable roller shafts provided at the lower ends of the front and rear walls of the crushing cavity. The outer surface of the roller shaft is fixed with a crushing roller. A rolling chamber is provided in the left wall of the crushing chamber and below the chute. A fourth motor is fixed in the upper wall of the rolling chamber. An eccentric wheel is connected to the lower end of the fourth motor, and the upper wall of the chute is in communication. With an arc-shaped cavity A slideway is provided between the lower wall and the right wall of the twisting cavity. An arc-shaped chute is provided on the front-rear wall of the side of the arc-shaped cavity away from the center of the circle. An arc-shaped slider extending into the arc-shaped chute, a lower end of the arc-shaped slider is fixedly provided with a hooking block along a radial direction, and an electromagnet is fixedly mounted on a lower end of the hooking block perpendicular to the radial direction.

Wherein, the steel wire removing device includes a linkage cavity connected to the center of the upper left corner of the crushing cavity, and the rotatable left end of the upper left corner of the crushing cavity extends to a flap in the linkage cavity, and the left wall of the crushing cavity is A storage cavity is communicated below the linkage cavity, and a second hydraulic arm rotatably connected between the front and rear walls of the storage cavity is provided in the storage cavity, and a connecting block is fixed on the lower end surface of the flap. The upper end of the second hydraulic arm is rotatably connected to the lower end of the connecting block.

Preferably, the right end of the lower end face of the slider is provided with a downwardly-closing clamping block cavity, and a clamping block is slidably arranged in the clamping block cavity, and the upper end of the clamping block and the upper wall of the clamping block cavity are provided. A second spring is fixedly connected between the lower wall of the sliding groove and the upper wall of the linkage cavity. A clamping groove is provided in the communication groove, and an abutment bar is slidably arranged in the sliding groove. A limiting groove is provided, and the end surface of the abutting rod is fixed in the limiting groove with a limiting block which can slide up and down in the limiting groove. The upper end surface of the limiting block and the limiting groove are provided on the limiting groove. A third spring is fixedly connected between the walls, and when the lower end of the clamping block extends into the card slot and abuts the upper end of the abutting rod, the limiting block and the abutting rod are in a lower limit position, and the limit When the position block and the abutment rod slide to the upper limit position, the clamping block is pushed back into the clamping block cavity.

Preferably, a toothed plate groove communicating with the inlet to the right is provided on the rear end surface of the sliding groove and behind the slider, and the front end surface of the toothed plate groove that is slidable to the left and right is fixedly connected to In the tooth plate of the slider, the upper left corner of the crushing cavity and a lower part of the tooth plate groove are provided with an engaging cavity which is upwardly communicated with the tooth plate groove, and the left end of the flip plate is at the position of the engaging cavity. A ratchet groove with an opening to the left is provided vertically, and a ratchet having a front end surface fixedly connected to the front wall of the ratchet groove is provided in the ratchet groove, and the center of the rear end surface of the ratchet gear is rotatably connected to the rear wall of the ratchet groove. The lower end of the tooth plate is engaged with the ratchet wheel in the engaging cavity. When the flip plate is turned downward, the ratchet wheel will not drive the tooth plate to slide. When the flip plate is turned upward, the ratchet wheel Driving the tooth plate to slide.

Wherein, the crushing device includes a gear cavity provided in a rear wall of the crushing cavity and behind the crushing roller, a rear end of the crushing roller on the left side extends into the gear cavity and a first gear is fixedly provided The rear end of the crushing roller on the right extends into the gear cavity and is fixedly provided with a second gear meshing with the first gear. A first motor is fixed on the rear wall of the gear cavity. The rear end of the crushing roller is dynamically connected to the front end of the first motor.

Preferably, a conveying cavity is communicated with the lower wall of the crushing cavity, and a downward opening is connected to the left side of the lower end surface of the conveying cavity. The left and right ends of the conveying cavity are symmetrical and rotatable between the front and rear walls. A conveying shaft is provided, and a conveying wheel is fixed on the outer surface of the conveying shaft, and a conveying belt is wound between the conveying wheels.

Preferably, a second motor is fixed in the rear wall of the conveying cavity and behind the conveying shaft on the right side, and the rear end of the conveying shaft on the right side is dynamically connected to the front end of the second motor, and the first Two motors provide power to convey the broken tire rubber.

Wherein, the twisting device includes a fourth spring fixedly disposed between the right end surface of the arc-shaped slider and the lower wall of the arc-shaped chute, and a coil winding cavity is provided in the lower wall of the arc-shaped cavity. A third motor is fixed in the right wall of the reeling cavity, and a reel having a right end power connected to the third motor is rotatably installed in the reeling cavity, and one end of the reel is fixedly connected to the reel. A pull line at the right end of the arc-shaped slider.

Preferably, a through hole is provided between the lower wall of the twisting cavity and the upper wall of the conveying cavity, and an upper end of the through hole is provided with a rear end rotatably connected between the left and right walls of the through hole. A twisting bottom plate is provided with a filter groove passing through the center of the twisting bottom plate, and a filter screen is fixed at the upper end of the filtering groove.

Preferably, a third hydraulic arm is rotatably provided on the front wall of the through opening, and an upper end of the third hydraulic arm is rotatably connected to a lower end surface on the front side of the twisting bottom plate, and the upper side of the front wall of the twisting bottom plate is communicated with The wire outlet opening forward is driven to turn the twisting bottom plate downward when the third hydraulic arm contracts, and the upper end surface of the twisting bottom plate is rolled out to remove residual rubber through the wire outlet.

The beneficial effect of the present invention is that the present invention can quickly and accurately pull out the steel wire layer in the tire and twist the broken rubber stuck on the steel wire cleanly, so that the steel wire and the tire rubber and other recyclable materials are separated, and at the same time, it has been pulled out. The steel wire tire is broken into small pieces of rubber, which is convenient for the next processing, which not only saves a lot of material costs for the enterprise, but also saves a lot of time and labor costs.

### BRIEF DESCRIPTION OF THE DRAWINGS

For ease of description, the present invention is described in detail by the following specific embodiments and the accompanying drawings.

FIG. 1 is a schematic diagram of the overall structure of a device for recycling waste tires according to the present invention; FIG.

FIG. 2 is a cross-sectional view taken along the “A-A” direction of FIG. 1; FIG.

3 is a cross-sectional view taken along the “B-B” direction of FIG. 1;

4 is a cross-sectional view taken along the “C-C” direction of FIG. 1;

5 is a cross-sectional view taken along the “D-D” direction of FIG. 1;

FIG. 6 is an enlarged schematic view of “E” in FIG. 1.

### DETAILED DESCRIPTION OF THE INVENTION

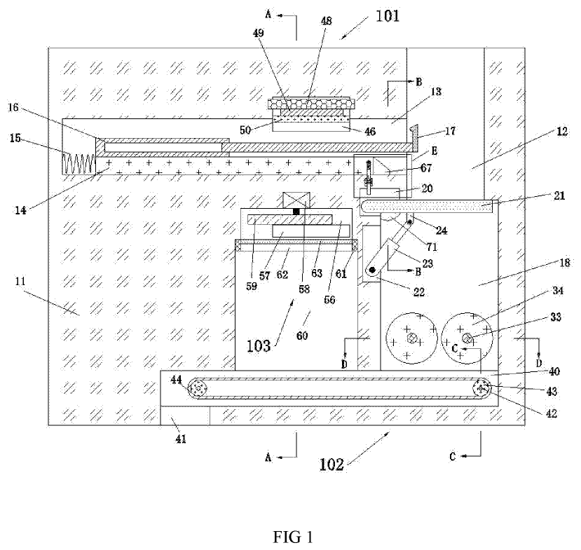

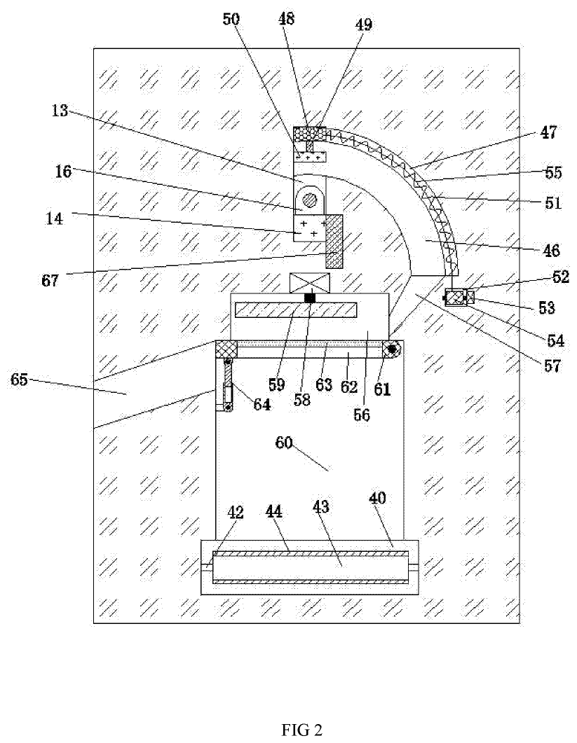

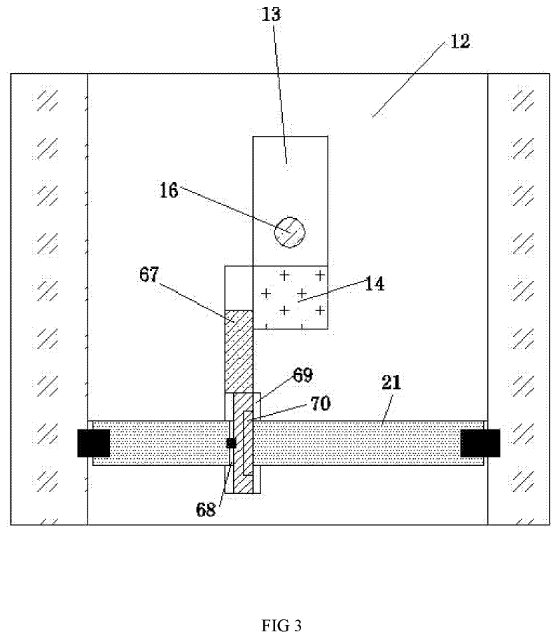

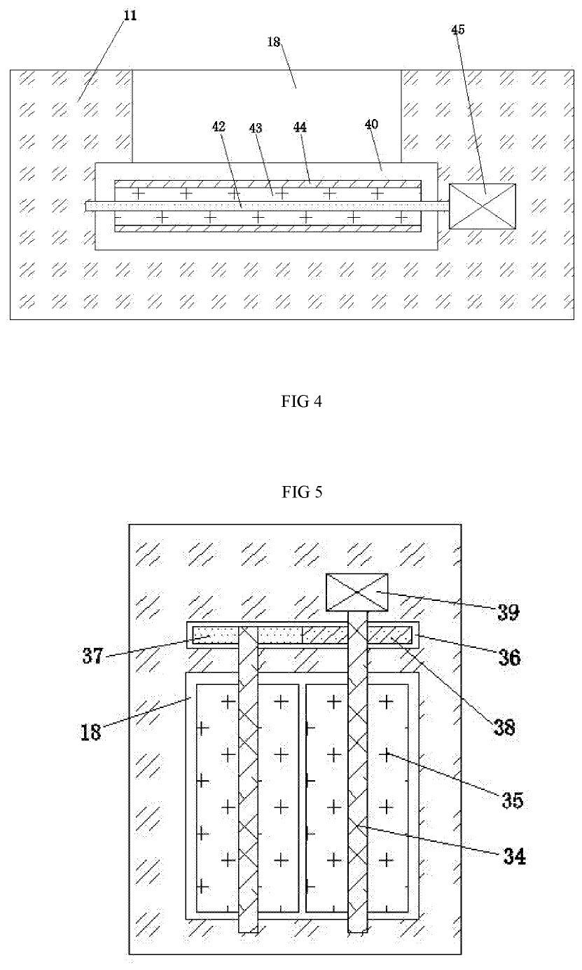

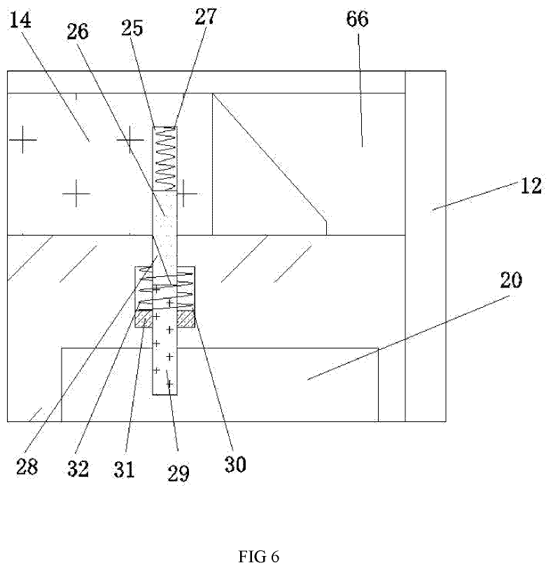

The present invention will be described in detail below with reference to FIGS. 1-6. For convenience of description, the orientation described below is defined as follows: the up-down, left-right, front-back direction described below is consistent with the up-down, left-right, front-back direction of the projection relationship of FIG. 1 itself.

The invention relates to a device for recycling waste tires, which is mainly used for recycling tires containing steel wire layers. The invention will be further described below with reference to the accompanying drawings of the invention:

The equipment for recycling waste tires according to the present invention comprises a machine body 11, an upper opening 12 is provided on the right side of the upper end surface of the machine body 11, and a chute 13 is provided on the left wall of the inlet 12 in communication. A wire removing device 101 is provided in the chute 13. The wire removing device 101 includes a slider 14 slidably arranged in the chute 13 between the left end of the slider 14 and the chute 13. A first spring 15 is fixedly connected, a first hydraulic arm 16 is fixed on the upper end surface of the slider 14, a hook 17 is fixed on the right end of the first hydraulic arm 16, and a crushing cavity 18 is connected to the lower wall of the inlet 12. A crushing device 102 is fixed in the crushing cavity 18. The crushing device 102 includes a roller shaft 33 symmetrically and rotatably provided at the lower ends of the front and rear walls of the crushing cavity 18, and the outer surface of the roller shaft 33 is fixed. A crushing roller 34 is provided. A rolling cavity 56 is provided in the left wall of the crushing cavity 18 and below the chute 13. A rolling device 103 is provided in the rolling cavity 56. A fourth motor 58 in the upper wall of the twisting cavity 56 is described. In the core wheel 59, an arc-shaped cavity 46 is provided on the upper wall of the chute 13, and a slide channel 57 is provided between the lower wall of the arc-shaped cavity 46 and the right wall of the twisting cavity 56. The arc-shaped cavity 46 An arc-shaped chute 47 is communicated with the front and rear walls of a side far from the center of the circle. The arc-shaped cavity 46 is slidably provided with an arc-shaped slider 48 extending from the front and rear ends to the arc-shaped chute 47. The lower end surface of the arc-shaped slider 48 is fixedly provided with a hooking block 49 along the radial direction, and the lower end of the hooking block 49 is fixed with an electromagnet 50 perpendicular to the radial direction.

According to an embodiment, the steel wire removing device 101 is described in detail below. The steel wire removing device 101 includes a linkage cavity 20 connected to the center of the upper left corner of the crushing cavity 18, and the rotatable left end of the upper left corner of the crushing cavity 18 extends to A flap 21 in the linkage cavity 20, a left wall of the crushing cavity 18, and a communication cavity 22 is provided below the linkage cavity 20, and the storage cavity 22 is provided with a lower end rotatably connected to the storage cavity. A second hydraulic arm 23 between the front and rear walls of the cavity 22, a connecting block 24 is fixed on the lower end surface of the flap 21, and an upper end of the second hydraulic arm 23 is rotatably connected to the lower end of the connecting block 24.

Beneficially, a clamping block cavity 25 with a downward opening is provided at the right end of the lower end surface of the slider 14, and a clamping block 26 is slidably arranged in the clamping block cavity 25. The upper end of the clamping block 26 and the clamping block A second spring 27 is fixedly connected between the upper walls of the cavity 25, and a catch groove 28 is provided between the lower wall of the slide groove 13 and the upper wall of the linkage cavity 20. Abutment rod 29, a limiting groove 30 is provided on the side wall of the clamping groove 28, and a limit surface 30 is fixed on the end surface of the abutting rod 29 in the limiting groove 30 to slide up and down in the limiting groove 30. Block 31, a third spring 32 is fixedly connected between the upper end surface of the limiting block 31 and the upper wall of the limiting groove 30, and the lower end of the clamping block 26 extends into the clamping groove 28 and is connected with the abutting rod When the upper end of 29 is in contact, the limiting block 31 and the abutting rod 29 are in a lower limit position. When the limiting block 31 and the abutting rod 29 slide to the upper limit position, the clamping block 26 is pushed back to the Within the block cavity 25.

Beneficially, a tooth plate groove 66 communicating with the inlet 12 to the right is provided on the rear end surface of the slide groove 13 and behind the slider 14. A front surface is provided in the tooth plate groove 66 that can slide left and right. The upper end is fixedly connected to the tooth plate 67 of the slider 14, and the upper left corner of the crushing cavity 18 is provided below the tooth plate groove 66 with an engagement cavity 69 communicating with the tooth plate groove 66 upward. A left ratchet groove 68 is provided at the left end of the plate 21 and penetrates up and down at the position of the engaging cavity 69. The ratchet groove 68 is provided with a ratchet 70 with a front end fixedly connected to the front wall of the ratchet groove 68. The center of the rear end surface of the ratchet wheel 70 is rotatably connected to the rear wall of the ratchet groove 68. The lower end of the tooth plate 67 meshes with the ratchet wheel 70 in the engaging cavity 69. The ratchet wheel 70 does not drive the tooth plate 67 to slide. When the flip plate 21 is turned upward, the ratchet wheel 70 drives the tooth plate 67 to slide.

According to the embodiment, the crushing device 102 is described in detail below. The crushing device 102 includes a gear cavity 36 provided in the rear wall of the crushing cavity 18 and behind the crushing roller 34, and the crushing roller 34 on the left side. The rear end extends into the gear cavity 36 and is fixedly provided with a first gear 37, and the rear end of the crushing roller 34 on the right side extends into the gear cavity 36 and is fixedly provided with a mesh with the first gear 37 The second gear 38 is provided with a first motor 39 fixed in the rear wall of the gear cavity 36, and the rear end of the crushing roller 34 on the right side is dynamically connected to the front end of the first motor 39.

Beneficially, a conveying cavity 40 is communicated with the lower wall of the crushing cavity 18, and a lower opening 41 is connected to the left side of the lower end surface of the conveying cavity 40. The conveying cavity 40 is symmetrical between the left and right ends and the front and rear walls. A conveying rotating shaft 42 is rotatably provided. A conveying wheel 43 is fixed on the outer surface of the conveying rotating shaft 42. A conveying belt 44 is wound between the conveying wheels 43.

Beneficially, a second motor 45 is fixed in the rear wall of the conveying cavity 40 and behind the conveying shaft 42 on the right side, and the rear end of the conveying shaft 42 on the right side is dynamically connected to the front end of the second motor 45 The second motor 45 provides power to convey the broken tire rubber.

According to the embodiment, the twisting device 103 is described in detail below. The twisting device 103 includes a fourth spring 51 fixedly disposed between the right end face of the arc-shaped slider 48 and the lower wall of the arc-shaped chute 47. A coil winding chamber 52 is provided in the lower wall of the arc-shaped cavity 46, a third motor 53 is fixed in the right wall of the coil winding chamber 52, and a right end is rotatably provided in the coil winding chamber 52 to be connected to the right end. The winding drum 54 of the third motor 53 is provided with a pull wire 55 around which one end is fixedly connected to the right end surface of the arc-shaped slider 48.

Beneficially, a through hole 60 is provided between the lower wall of the twisting cavity 56 and the upper wall of the conveying cavity 40, and the upper end of the through hole 60 is provided with a rear end rotatably connected to the left and right sides of the through hole 60. A twisting bottom plate 61 between the walls is provided with a filter groove 62 penetrating vertically from the center of the twisting bottom plate 61, and a strainer 63 is fixed at the upper end of the filter groove 62.

Beneficially, a third hydraulic arm 64 is rotatably provided on the front wall of the through-port 60, and the upper end of the third hydraulic arm 64 is rotatably connected to the lower end surface of the front side of the twisted bottom plate 61, and the front wall of the twisted bottom plate 61 A wire outlet 65 with an opening forward is connected to the upper part. When the third hydraulic arm 64 contracts, the twisting bottom plate 61 is turned downward. The upper end surface of the twisting bottom plate 61 is rolled to remove residual rubber and passes through the wire outlet. 65 slide out.

The following describes in detail the use steps of a device for recycling waste tires in this article with reference to FIGS. 1 to 6:

At the beginning, the slider 14 is located at the left limit position, the first hydraulic arm 16 is in an extended state, and the second hydraulic arm 23 is in an extended state. The block 26 is placed into the slot 28, and the lever 29 and the limit block 31 is in the lower limit position, the arc-shaped slider 48 is in the upper limit position, the twisting bottom plate 61 is in a horizontal state, and the third hydraulic arm 64 is in an extended state.

When working, the tire falls obliquely into the entrance 12, the second hydraulic arm 23 shrinks to drive the flap 21 downward and the tire falls downward, and the second hydraulic arm 23 shrinks to drive the flap 21 to flip downward. The lower end of the rod 29 abuts and pushes the abutment rod 29 to slide up. The abutment rod 29 pushes the block 26 back into the block cavity 25. Then the slider 14 is ejected by the first spring 15 and the right end of the first hydraulic arm 16 extends to In the center of the falling tire, the tire is hung on the right end of the first hydraulic arm 16 and on the left side of the hook 17. The first hydraulic arm 16 contracts and drives the hook 17 and the tire to slide to the left. When the tire meets the left wall of the entrance 12, the first hydraulic arm 16 continues to shrink, the hook 17 tears the tire and pulls the steel wire layer inside the tire into the chute 13, the electromagnet 50 is energized to suck the steel wire, and the third motor 53 is started to drive the spool 54 to rotate, and the spool 54 is wound. The winding wire 55 further pulls the arc-shaped cavity 46 to slide to the lower limit position, the electromagnet 50 is de-energized, and the wire leaves the electromagnet 50 and slides into the twisting cavity 56 through the slide 57. At this time, the arc-shaped slider 48 is at the fourth spring 51 To the upper limit position, the fourth motor 58 starts to drive the eccentric 59 The eccentric wheel 59 twists the broken rubber stuck on the surface of the steel wire in the twisting cavity 56 and falls into the through hole 60 through the filter 63 and the filter groove 62, and then falls to the upper end surface of the conveyor belt 44 in the conveying cavity 40 and twists When finished, the third hydraulic arm 64 shrinks and turns the twisting bottom plate 61 to tilt downward to the left. The wire on the upper end of the filter 63 slides out from the wire outlet 65. When the wire layer is pulled away from the tire, the tire falls into the crushing cavity 18, The first motor 39 is started to drive the right crushing roller 34 to rotate, and then the crushing roller 34 is rotated toward each other through the gear meshing. The crushing roller 34 crushes and crushes the tire in the crushing cavity 18, and the crushed rubber falls into the conveyor belt in the conveying cavity 40. At the upper end of 44, the second motor 45 starts to drive the right-hand conveying shaft 42 to rotate, which in turn drives the conveying belt 44 to rotate and convey the shredded rubber to the left. The shredded rubber falls out of the opening 41 and waits for subsequent processing. The second hydraulic arm 23 The extension drives the flap 21 to flip upwards, and at the same time drives the tooth plate 67 to slide to the left through the ratchet 70, and then the slider 14 slides to the left, and the block 26 springs into the slot 28 to be locked again under the action of the second spring 27. The first hydraulic arm 16 of the device is extended and installed Restored to its original state.

The beneficial effect of the present invention is that the present invention can quickly and accurately pull out the steel wire layer in the tire and twist the broken rubber stuck on the steel wire cleanly, so that the steel wire and the tire rubber and other recyclable materials are separated, and at the same time, it has been pulled out. The steel wire tire is broken into small pieces of rubber, which is convenient for the next processing, which not only saves a lot of material costs for the enterprise, but also saves a lot of time and labor costs.

In the above manner, those skilled in the art can make various changes according to the working mode within the scope of the present invention.

1. An equipment for recycling waste tires includes a machine body, an upper opening entrance is provided on the right side of the upper end surface of the machine body, a left groove is connected to a left wall of the entrance, and a steel wire removing device is provided in the slide groove. The wire removing device includes a slider provided in the chute that can slide left and right, a first spring is fixedly connected between the left end of the slider and the chute, and a first end of the slider is fixedly provided with a first spring. A hydraulic arm, a hook is fixed at the right end of the first hydraulic arm;
a crushing cavity is communicated with the lower wall of the inlet, and a crushing device is fixed in the crushing cavity. The crushing device includes left and right symmetrical and rotatable roller shafts provided at the lower ends of the front and rear walls of the crushing cavity. Crushing rollers are fixed on the outer surface;
a rolling chamber is provided in the left wall of the crushing chamber and below the chute. A rolling device is provided in the rolling chamber. The rolling device includes a fourth motor fixedly arranged in the upper wall of the rolling chamber. An eccentric wheel is dynamically connected to the lower end of the fourth motor, an arc-shaped cavity is connected to the upper wall of the chute, and a slideway is provided to communicate between the lower wall of the arc-shaped cavity and the right wall of the rolling cavity. An arc-shaped chute is connected to the front and rear walls of the cavity remote from the center of the circle. The arc-shaped chamber is slidably provided with an arc-shaped slider extending from the front and rear ends to the arc-shaped chute. The lower end surface of the block is fixedly provided with a hooking block along the radial direction, and the lower end of the block is fixed with an electromagnet perpendicular to the radial direction.

2. The equipment for recycling used tires according to claim 1, wherein the wire removing device comprises a linkage chamber communicating with the center of the upper left corner of the crushing cavity, and the upper left corner of the crushing cavity is rotatable. The left end extends to the flap in the linkage cavity;
a storage cavity is provided on the left wall of the crushing cavity and below the linkage cavity, and a second hydraulic arm rotatably connected between the front and rear walls of the storage cavity is provided in the storage cavity, and the flap A connection block is fixed on the lower end surface, and the upper end of the second hydraulic arm is rotatably connected to the lower end of the connection block.

3. The equipment for recycling waste tires according to claim 1, characterized in that: the right end of the lower end surface of the slider is provided with a block cavity which is opened downward, and the block cavity which can be slid up and down is provided. There is a clamping block, and a second spring is fixedly connected between the upper end of the clamping block and the upper wall of the clamping block cavity;
a clamping groove is communicated between the lower wall of the sliding groove and the upper wall of the linkage cavity. An abutment bar is slidably arranged in the clamping groove, and a limiting groove is communicated with the side wall of the clamping groove. A limiting block that can slide up and down in the limiting groove is fixedly arranged on the end surface of the rod side, and a third block is fixedly connected between the upper end surface of the limiting block and the upper wall of the limiting groove;
when the lower end of the clamping block extends into the slot and is in contact with the upper end of the abutment rod, the limit block and the abutment rod are in a lower limit position, and the limit block and the abutment rod slide to an upper limit. When in position, the clip is pushed back into the cavity of the clip.

4. The equipment for recycling waste tires according to claim 1, characterized in that: the rear end surface of the chute and a rear side of the slider are provided with a toothed plate groove which communicates with the inlet to the right, A tooth plate that is slidably left and right in the tooth plate groove and is provided with a front end surface fixedly connected to the slider;
the upper left corner of the crushing cavity is provided below the tooth plate groove with an engagement cavity communicating upwardly with the tooth plate groove, and the left end of the flap is provided with an opening penetrating upward and downward at the position of the engagement cavity to the left. The ratchet groove is provided with a ratchet whose front end surface is fixedly connected to the front wall of the ratchet groove. The center of the rear end surface of the ratchet is rotatably connected to the rear wall of the ratchet groove. The engagement cavity is engaged with the ratchet wheel. When the flip plate is turned down, the ratchet wheel will not drive the tooth plate to slide. When the flip plate is turned up, the ratchet wheel will drive the tooth plate to slide.

5. The equipment for recycling waste tires according to claim 1, wherein the crushing device comprises a gear cavity provided in a rear wall of the crushing cavity and behind the crushing roller, The rear end of the crushing roller extends into the gear cavity and is fixedly provided with a first gear, and the rear end of the crushing roller extends to the gear cavity and is fixedly provided with a first gear meshing with the first gear. Two gear
a first motor is fixed in the rear wall of the gear cavity, and the rear end of the crushing roller on the right side is dynamically connected to the front end of the first motor.

6. The equipment for recycling waste tires according to claim 1, characterized in that: the lower wall of the crushing cavity is provided with a conveying cavity in communication, and the left side of the lower end of the conveying cavity is provided with an opening downwardly communicating The conveying shaft is symmetrically and rotatably provided between the left and right ends of the conveying cavity. The conveying shaft is fixed on the outer circular surface of the conveying shaft. A conveying belt is wound around the conveying wheel.

7. The equipment for recycling waste tires according to claim 6, wherein a second motor is fixedly arranged in the rear wall of the conveying cavity and behind the conveying shaft on the right side, The rear end of the conveying shaft is power-connected to the front end of the second motor, and the second motor provides power to convey the broken tire rubber out.

8. The equipment for recycling waste tires according to claim 1, wherein the twisting device comprises a fixedly disposed between a right end surface of the arc-shaped slider and a lower wall of the arc-shaped chute. A fourth spring, a coil winding cavity is provided in the lower wall of the arc-shaped cavity, and a third motor is fixed in the right wall of the coil winding cavity;
a winding reel with a right end power-connected to the third motor is rotatably provided in the winding reel cavity, and a pull wire with one end fixedly connected to the right end of the arc-shaped slider is wound around the winding reel.

9. The equipment for recycling used tires according to claim 1, characterized in that a communication port is provided between the lower wall of the rolling chamber and the upper wall of the conveying chamber, and the rear end of the upper end of the communication port A twisting bottom plate rotatably connected between the left and right walls of the opening is provided at the rear end, and a filter trough is provided through the center of the twisting bottom plate, and a filter screen is fixed at the upper end of the twisting bottom plate.

10. The equipment for recycling waste tires according to claim 9, wherein a third hydraulic arm is rotatably provided on the front wall of the port, and an upper end of the third hydraulic arm is rotatably connected to the third hydraulic arm. The lower end face of the front side of the twisting bottom plate, a wire outlet opening forward is communicated above the front wall of the twisting bottom plate, and the third hydraulic arm drives the twisting bottom plate to turn down when the third hydraulic arm contracts, and the upper end surface of the twisting bottom plate is twisted The steel wire from which the residual rubber is removed slides out through the wire outlet.
